(19) United States
(12) Patent Application Publication
(10) Pub. No.: US 2011/0165298 A1
(43) Pub. Date: Jul. 7, 2011

(54) COLLAPSIBLE BOTTLES AND METHODS OF USING SAME

(75) Inventors: Seung Hong, Dublin, OH (US); Robert Lepior, Powell, OH (US)

(73) Assignee: NESTEC S.A., Vevey (CH)

(21) Appl. No.: 13/051,293

(22) Filed: Mar. 18, 2011

Related U.S. Application Data
(62) Division of application No. 11/846,386, filed on Aug. 28, 2007.

(51) Int. Cl. B65D 85/72; B67D 7/00; B65G 57/03; B65G 57/16; G01F 11/00

(52) U.S. Cl. 426/397; 222/1; 414/802

(57) ABSTRACT

Collapsible bottles and methods of using the collapsible bottles are provided. In an embodiment, the collapsible bottle comprises a top panel having a neck, a middle panel foldable along a fold between the top panel and the middle panel, and a bottom panel comprising a bottom surface defining a molded recess so constructed and arranged for receiving a neck of a second bottle within the molded recess. The bottom panel is foldable along a fold between the middle panel and the bottom panel. The bottle is foldable into a collapsed position wherein the top panel folds into the middle panel and the middle panel folds into the bottom panel.

### BACKGROUND

The present disclosure is generally directed to containers. More specifically, the present disclosure is directed to collapsible bottles and methods of using the collapsible bottles.

There are numerous types of bottles currently being used. Such bottles are generally bulky and take up considerable amounts of space when stacked and/or stored together. Accordingly, bottles that provide convenient storage and space savings can lead to enhanced marketability with consumers.

### SUMMARY

The present disclosure is directed to collapsible bottles and methods of using the collapsible bottles. In an embodiment, the present disclosure provides a collapsible bottle comprising a top panel having a neck, a middle panel foldable along a fold between the top panel and the middle panel, and a bottom panel comprising a bottom surface defining a molded recess so constructed and arranged for receiving a neck of a second bottle partially or entirely within the molded recess. The bottom panel is foldable along a fold between the middle panel and the bottom panel. The bottle is foldable into a collapsed position wherein the top panel folds into the middle panel and the middle panel folds into the bottom panel.

In an embodiment, the neck comprises a closure.

In an embodiment, the neck comprises a compressible silicon valve seal positioned underneath the closure.

In an embodiment, the closure comprises a hinged flip top cap.

In an embodiment, the closure comprises a twist screw cap.

In an embodiment, the closure comprises a detachable pull tab.

In an embodiment, the bottom panel comprises a bottom surface defining a molded recess so constructed and arranged for receiving a closure of a second bottle partially or entirely within the molded recess.

In an embodiment, the neck remains above an upper end of the bottom panel in the collapsed position.

In an embodiment, the top panel, middle panel and bottom panel comprise a circular cross-sectional shape.

In an embodiment, the bottom panel comprises a square cross-sectional shape.

In an embodiment, the bottle comprises a height of between about 110 mm to about 305 mm in an elongated position and a height of between about 50 mm to about 90 mm in the collapsed position.

In an embodiment, the bottom panel comprises a diameter of about 50 mm to about 100 mm.

In an embodiment, at least one of the top panel, middle panel and bottom panel comprises a wall thickness between about 100 microns to about 300 microns.

In an embodiment, the bottle comprises a total weight between about 5 grams to about 30 grams.

In an embodiment, the bottle comprises a volume between about 6 to about 24 fluid ounces in the expanded position and a volume between about 2 to about 6 fluid ounces in the collapsed position.

In an embodiment, the bottle comprises a beverage concentrate in a form selected from the group consisting of powder, liquid, paste and combinations thereof.

In an embodiment, the top, middle and bottom panels comprise a material selected from the group consisting of polyethylene terephthalate, polypropylene, high-density polyethylene, low density polyethylene, polylactic acid, or other polymers or suitable materials and combinations thereof.

In another embodiment, the present disclosure provides a bottle comprising a top panel comprising a neck, a middle panel foldable along a fold between the top panel and the middle panel and a bottom panel comprising a bottom surface defining a molded recess so constructed and arranged for receiving a neck of a second bottle partially or entirely within the molded recess. The bottom panel is foldable along a fold between the middle panel and the bottom panel. The middle panel is wider than the top panel, and the bottom panel is wider than the middle panel. The bottle is foldable into a collapsed position wherein the top panel folds into the middle panel and the middle panel folds into the bottom panel.

In still another embodiment, the present disclosure provides a bottle comprising a top panel comprising a neck, a middle panel foldable along a plurality of folds between the top panel and the middle panel and a bottom panel comprising a bottom surface defining a molded recess so constructed and arranged for receiving a neck of a second bottle within the molded recess. The middle panel is foldable along the plurality of folds between the top panel and the bottom panel. The bottle is foldable into a collapsed position wherein the plurality of folds are compressed upon on each other.

In an alternative embodiment, the present disclosure provides a method of providing a bottled liquid. The method comprises providing a vending machine comprising a collapsible bottle, dispensing a collapsible bottle from the vending machine, and dispensing a liquid into the collapsible bottle.

In another embodiment, the vending machine comprises a plurality of the collapsible bottles in a collapsed position stacked on top of one another.

In another embodiment, the liquid is selected from the group consisting of water, coffee, tea, juice, milk, dairy-based drinks (including yogurt), soy-based drinks, cereal-based drinks, fruit-based drinks, soda, slush, nutritional drink and combinations thereof.

In another embodiment, the collapsible bottle comprises a powdered beverage (e.g. in the form of a concentrate). The beverage concentrate can also be in the form of a viscous paste or frozen concentrate. Alternatively, the collapsible bottle can comprises a liquid beverage concentrate

In yet another embodiment, the present disclosure provides a method of selling a beverage. The method comprises providing a vending machine comprising a beverage and a plurality of collapsible bottles in the collapsed position, wherein the bottles are stacked upon one another, dispensing a collapsible bottle from the vending machine, elongating the bottle, and dispensing a beverage from the vending machine into the collapsible bottle. In another embodiment, elongating the bottle and dispensing the beverage can be done within the vending machine using any suitable process.

In still another embodiment, the present disclosure provides a method of providing a beverage. The method comprises providing one or more collapsible bottles in the collapsed position, elongating the collapsible bottle; and dispensing a liquid into the collapsible bottle. The liquid can be dispensed from a beverage dispensing machine. The collapsible bottles can be stacked upon one another on a rack.

An advantage of the present disclosure is to provide improved bottles.

Another advantage of the present disclosure is to provide improved bottles that are collapsible.

Yet another advantage of the present disclosure is to provide improved bottles that are stackable.

Still another advantage of the present disclosure is to provide improved hygienic bottles.

Moreover, another advantage of the present disclosure is to provide improved methods of providing beverages in a bottle.

Yet another advantage of the present disclosure is to provide improved methods for selling beverages.

Additional features and advantages are described herein, and will be apparent from, the following Detailed Description and the figures.

### BRIEF DESCRIPTION OF THE FIGURES

FIG. 1 illustrates a perspective view of the collapsible bottle in an embodiment of the present disclosure.

FIG. 2 illustrates a cross-section II of the collapsible bottle in FIG. 1.

FIG. 3 illustrates a perspective view of the collapsible bottle in a collapsed position and in a stacked configuration in another embodiment of the present disclosure.

FIG. 4 illustrates a cross-section IV of the stacked collapsible bottles in FIG. 3.

FIG. 5 illustrates a silicon valve seal and hinged flop top cap that covers the neck of the collapsible bottle in an alternative embodiment of the present disclosure.

FIG. 6 illustrates a cross-section VII of the silicon valve seal and hinged flop top cap in FIG. 5 in a closed position.

FIG. 7 illustrates a cross-section VII of the silicon valve seal and hinged flop top cap in FIG. 5 in an open position.

FIG. 8 illustrates a front elevation view of the collapsible bottle in an alternative embodiment of the present disclosure.

FIG. 9 illustrates a front elevation view of the collapsible bottle in FIG. 8 in a collapsed position.

### DETAILED DESCRIPTION

The present disclosure is directed to collapsible bottles and methods of using the collapsible bottles. Generally, in an embodiment, the bottle is constructed and arranged to be collapsed into a smaller configuration and stacked upon one another. This reduces the space necessary to transport and/or hold the bottles, for example, in a vending machine. During use, the bottle can comprise a spill-proof spout and be elongated to hold any suitable liquids. This provides a hygienic container for beverages that could be useful, for example, at any location where the beverage is dispensed into the container from a vending or dispensing machine. The bottle requires little space because it is collapsible, stackable, and expandable, and can be capped to prevent spilling or contamination.

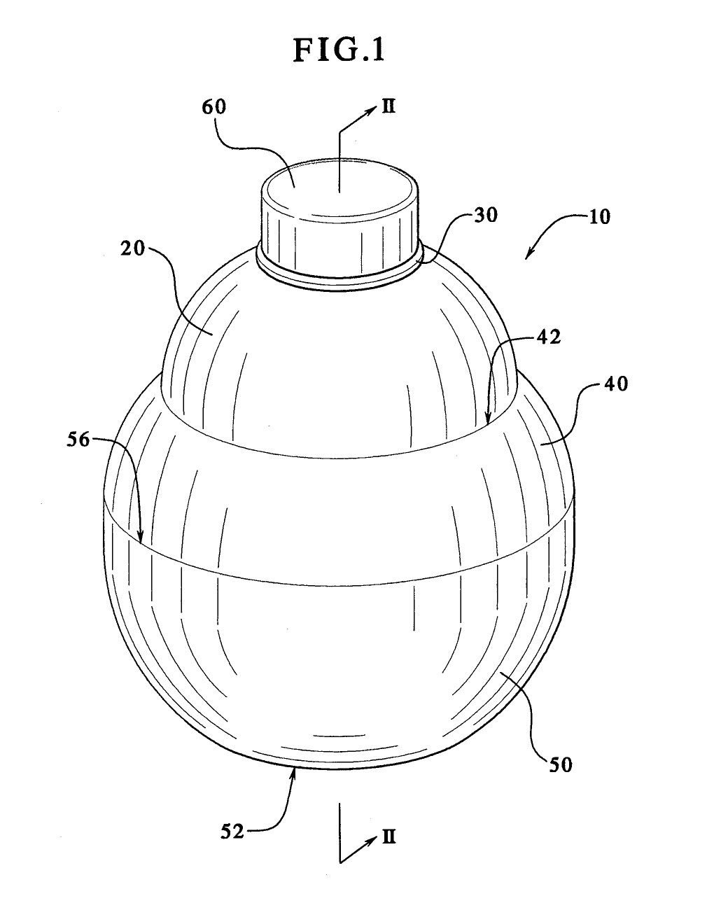

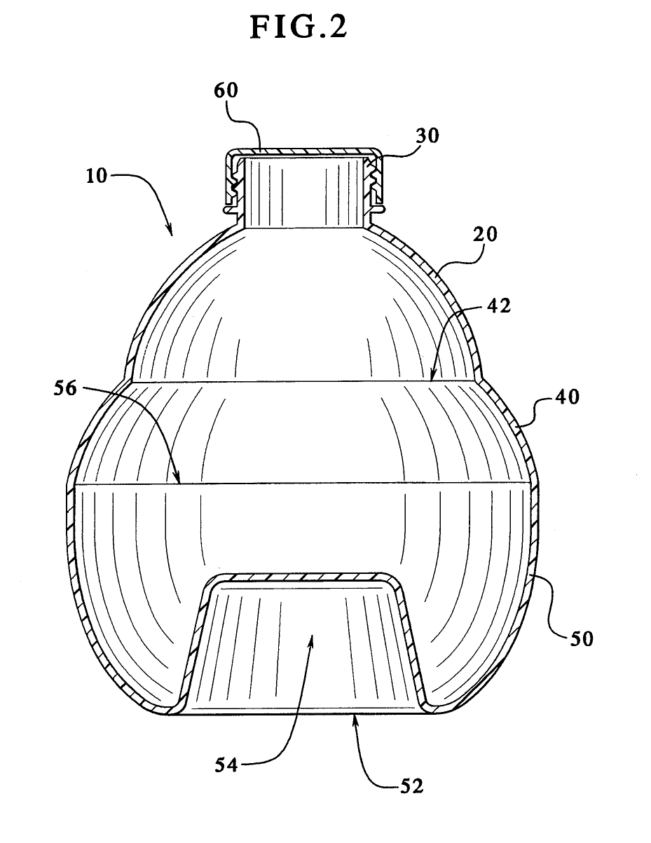

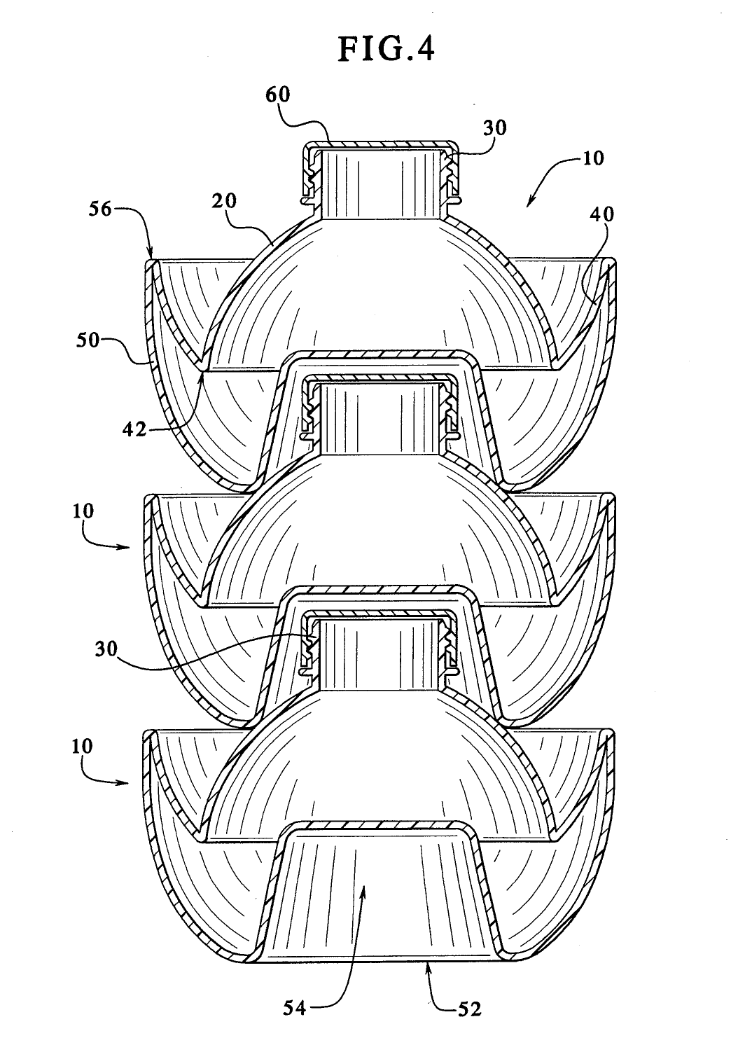

Referring now to FIGS. 1-4, in an embodiment, the present disclosure provides a collapsible bottle 10 comprising a top panel 20 having a neck 30 (e.g. spout) and a middle panel 40 foldable along a fold 42 between the top panel 20 and the middle panel 40. The collapsible bottle 10 further comprises a bottom panel 50 comprising a bottom surface 52 defining a molded recess 54 so constructed and arranged for receiving a neck of a second bottle partially or entirely within the molded recess 54. The bottom panel 50 is foldable along a fold 56 between the middle panel 40 and the bottom panel 50. In an embodiment, the middle panel is wider (e.g. greater diameter) than the top panel, and the bottom panel is wider than the middle panel.

The molded recess 54 can be constructed and arranged to so that the neck of the second bottle fits loosely or tightly therein. The second bottle can comprise the same configuration or a different configuration from the collapsible bottle 10. In addition, the bottom panel 50 can define a molded recess 54 that matches the exact shape of the neck of the second bottle. Alternatively, the bottom panel 50 can define a molded recess 54 that does not match the shape of the neck of the second bottle but is capable of entirely receiving the neck within the recess 54.

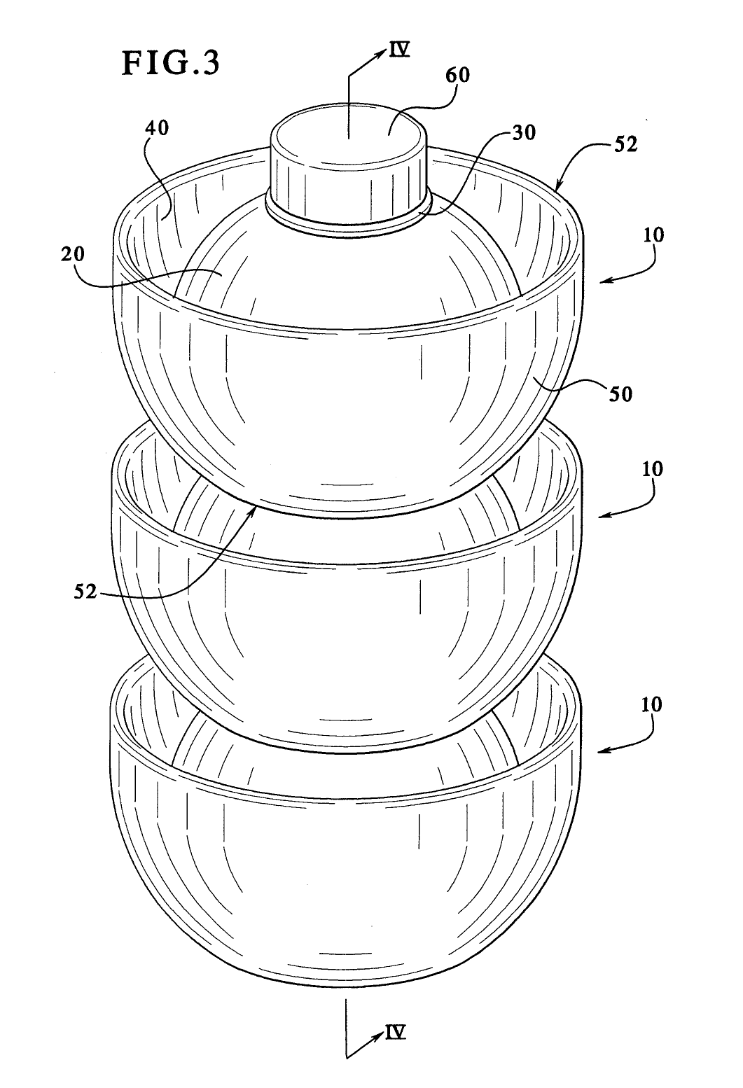

The bottle 10 is foldable into a collapsed position as shown in FIGS. 3-5 wherein the top panel 20 folds into the middle panel 40 and the middle panel 40 folds into the bottom panel 50. For example, in the collapsed position, the middle panel 40 folds inward toward the bottle 10 and becomes inverted within the bottom panel 50. As a result, the fold 42 is positioned below the fold 56 when the bottle 10 is in the collapsed position. In an embodiment, the neck 30 remains above an upper end (i.e. fold 56) of the bottom panel in the collapsed position.

The bottle can comprise any suitable outward shape in accordance with embodiments of the present disclosure. For example, as shown in FIG. 1, the top panel, middle panel and bottom panel comprise a rounded or circular cross-sectional shape (e.g. as viewed from the top). In alternative embodiments, the panels can each comprise a different outward shape. For example, the top panel and middle panel can comprise a rounded cross-sectional shape while the bottom panel comprises a substantially square cross-sectional shape.

The bottle can comprise any suitable height in the elongated or collapsed positions. For example, the bottle can comprise a height of between about 110 mm to about 305 mm in an elongated position and a height of between about 50 to about 90 mm in the collapsed position. The bottle can also comprise any suitable width/diameter. For example, the bottle can comprise panels having a width/diameter of about 50 to about 100 mm.

The bottle can comprise any suitable weight. For example, the bottle can comprise a total weight between about 5 to about 30 grams. Preferably, the bottle comprises a total weight between about 18 to about 24 grams. The bottle can also comprise any suitable volume in the extended position and the collapsed position. For instance, the bottle can comprise a volume between about 2 fluid ounces to about 6 fluid ounces in the collapsed position.

The bottle can be made, for example, by being preformed in a cylindrical or multi-sided shape and stretch blow-molded to preferably a sphere-typed shape. The bottle can then be mechanically collapsed to form the folds and capped with any suitable closure.

The bottle may utilize a thin-wall plastic technology, for example, that allows the bottle bend easily. The panels can comprise any suitable thickness. For example, the top panel, middle panel and/or bottom panel can comprise a wall thickness between about 100 to about 300 microns. In addition, the panels can comprise any suitable material such as, for example, an oxygen-barrier type material. In an embodiment, the top, middle and/or bottom panels comprises a material such as polyethylene terephthalate, polypropylene, high-density polyethylene, low density polyethylene, polylactic acid, or other polymers or suitable materials or combinations thereof.

As illustrated in FIGS. 1-4, in an embodiment, the neck 30 can comprise a closure 60. For example, the neck can comprise threads, and the closure can comprises a twist screw cap that twists onto and seals the neck. Accordingly, the bottom panel 50 comprises a bottom surface 52 defining a molded recess 54 so constructed and arranged for receiving a closure of a second bottle partially or entirely within the molded recess 54. Space savings are maximized when the molded recess 54 entirely receives the closure of the second bottle while the bottles are stack upon one another.

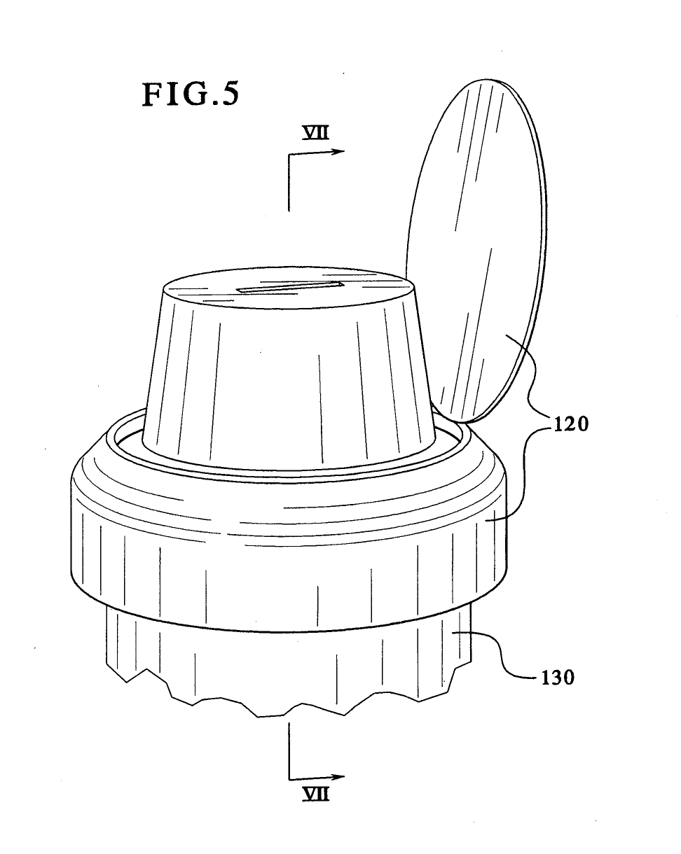

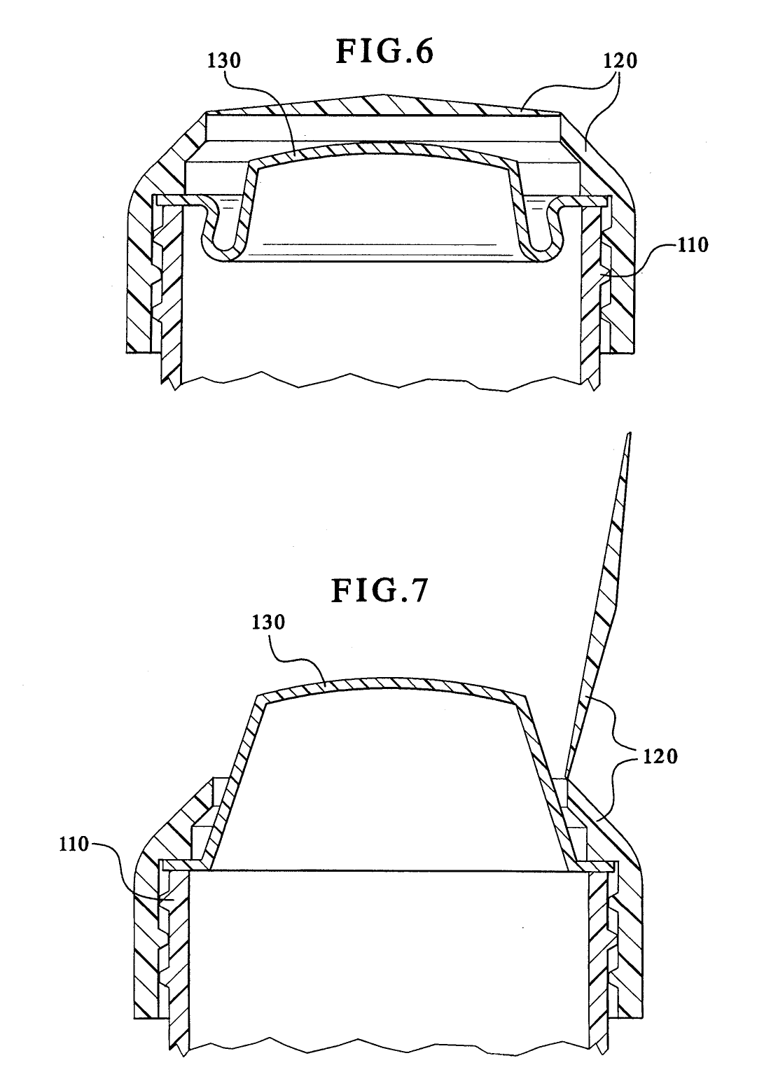

Referring now to FIGS. 5-7, in another embodiment, the neck 110 comprises a hinged flip top closure 120. The neck 110 also comprises a compressible valve seal 130 underneath the flip top closure 120. As shown in FIG. 6, the valve seal 130 can be constructed an arranged in a compressed position that fits underneath the flip top closure 120. When the flip top closure 120 is lifted, the valve seal 130 can be constructed and arranged to pop up, which allows a consumer to drink from an opening in the valve seal 130. The valve seal 130 can be used to prevent splashing or spilling of the beverage when the bottle is being used. Space savings are maximized, for example, when the valve seal 130 compresses underneath the flip top closure 120 thereby minimizing any protrusion of the drinking spout. The compressible valve seal 130 can be made of any suitable material such as, for example, silicon.

In alternative embodiments, any suitable type of closure can be used to cover or seal the neck of the bottle. For example, the closure can comprise a detachable pull tab. Any suitable spout (e.g. sports spout) can take the place of the valve seal inside the neck. Alternatively, the neck may not comprise any additional spout. The closure can be attached to the neck of the bottle in any suitable manner (e.g. threaded closure and neck, adhesive, snap-lock)

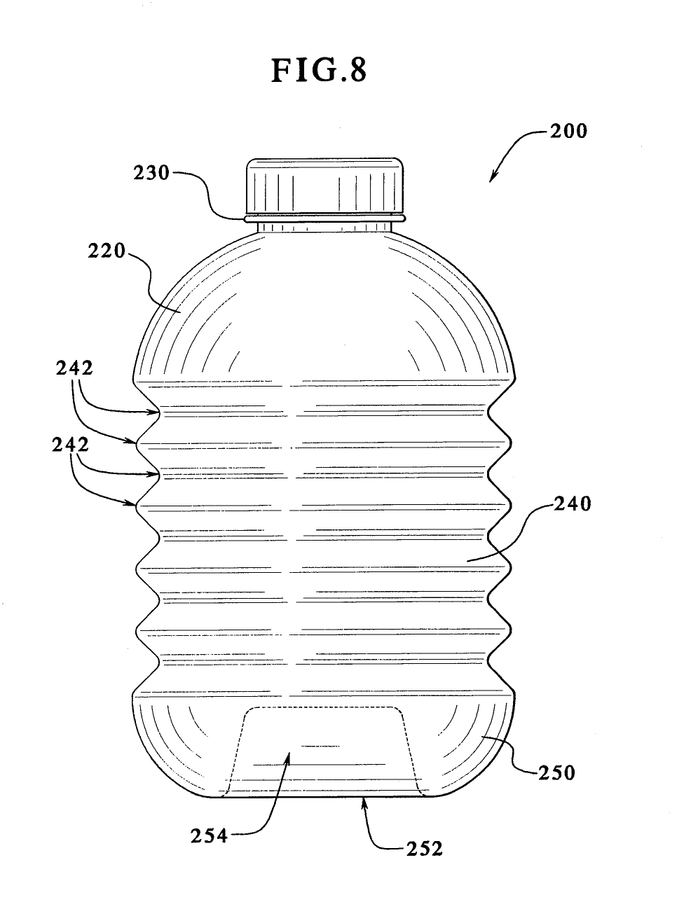

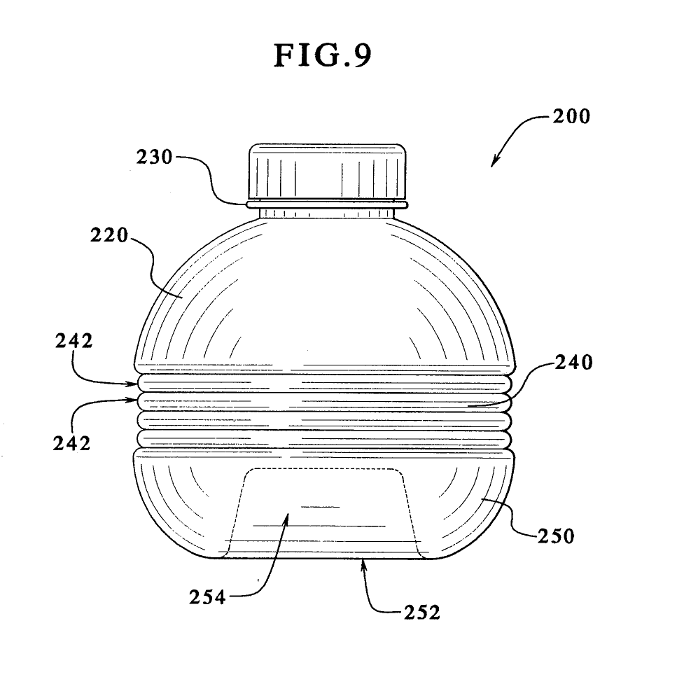

Referring now to FIGS. 8-9, in another embodiment, the present disclosure provides a bottle 200 comprising a top panel 220 comprising a neck 230, a middle panel 240 foldable along a plurality of folds 242 between the top panel 220 and the middle panel 240 and a bottom panel 250 comprising a bottom surface 252 defining a molded recess 254 so constructed and arranged for receiving a neck of a second bottle within the molded recess. The middle panel 240 is foldable along the plurality of folds 242 between the top panel 220 and the bottom panel 250. For example, the bottle 200 is foldable into a collapsed position as shown in FIG. 9 wherein the plurality of folds 242 are compressed upon on each other. The folds 242 can be constructed and designed so that the bottle 200 comprises any suitable height in the collapsed position.

In another embodiment, the present disclosure provides a method of stacking bottles. The method comprises providing a first collapsible bottle comprising a top panel, a middle panel, and a bottom panel. The bottom panel comprises a bottom surface defining a molded recess. The first collapsible bottle is foldable into a collapsed position wherein the top panel folds into the middle panel and the middle panel folds into the bottom panel. The first collapsible bottle is stacked on top of a second bottle by inserting a neck or closure of the second bottle partially or entirely into the molded recess of the first collapsible bottle. The second bottle can be collapsible and comprise the same configuration or a different configuration from the first collapsible bottle.

The first bottle and the second bottle can be in elongated or collapsed positions when stacked. Any suitable number of bottles can be stacked on top of each other in a similar manner. However, to optimize space, the bottles should be in the collapsed positions, for example, for shipment or storage. This saves shipping and storage costs. The bottles can be used in a vending machine or dispensers, for example, in space-saving stacks.

The bottle can comprise any suitable liquid such as, for example, water, coffee, tea, juice, milk, dairy-based drinks (including yogurt), soy-based drinks, cereal-based drinks, fruit-based drinks, soda, slush, nutritional drink or combinations thereof. In another embodiment, the bottle comprises a liquid or powdered beverage concentrate or paste (e.g. gel) within the bottle. The concentrate may be frozen, chilled or at ambient temperature. The consumer can then add a rehydrating liquid such as water to the bottle to make a beverage.

In an alternative embodiment, the present disclosure provides a method of providing a bottled liquid. The method comprises providing a vending machine comprising one or more collapsible bottles, dispensing a collapsible bottle from the vending machine, and dispensing a liquid into the collapsible bottle. The bottles can be stacked upon each other in the vending machine in the extended position or the collapsed position. The liquid can be dispensed from the same vending machine that contains the bottles or from a different vending machine or dispenser. Preferably, the bottles are capped to avoid contamination during transit or in the vending machine. During use, for example, the consumer inserts a payment into the vending machine and receives a collapsed bottle, which they would then uncap and extend prior to filling it from the vending machine.

The vending machine or dispenser can dispense any suitable liquid into the bottle. The liquid can be, for example, water, coffee, tea, juice, milk, dairy-based drinks (including yogurt), soy-based drinks, cereal-based drinks, fruit-based drinks, soda, slush, nutritional drink or combinations thereof. Alternatively, the bottle can contain a liquid or powdered beverage concentrate and a consumer can add a suitable diluting or rehydrating liquid such as water to form the bottled beverage.

In yet another embodiment, the present disclosure provides a method of selling a beverage. The method comprises providing a vending machine comprising a beverage and a plurality of collapsible bottles in the collapsed position, wherein the bottles are stack upon one another, dispensing a collapsible bottle from the vending machine, elongating the bottle, and dispensing a beverage from the vending machine into the collapsible bottle.

The consumer can also refill the bottle with a dispensed beverage from the vending machine or beverage dispenser for a discounted cost. Alternatively, the consumer can rinse and re-use the bottle for his or her own beverage later. The bottle can be reusable any number of times.

In still another embodiment, the present disclosure provides a method of providing a beverage. The method comprises providing one or more collapsible bottles in the collapsed position, elongating the collapsible bottle; and dispensing a liquid (e.g. water, juice, soda) into the collapsible bottle. The collapsible bottles can also comprise a beverage concentrate in a form such as a powder, liquid, paste or combination thereof. The liquid can be dispensed from any suitable beverage dispensing machine. The collapsible bottles can be stacked upon one another, for example, on a rack at any suitable location (e.g. gym, school, store) and provided to a consumer.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-15. (canceled)

16. A method of stacking bottles, the method comprising:
providing a first collapsible bottle comprising a top panel, a middle panel, and a bottom panel, the bottom panel comprising a bottom surface defining a molded recess, the first collapsible bottle foldable into a collapsed position wherein the top panel folds into the middle panel and the middle panel folds into the bottom panel; and
stacking the first collapsible bottle on top of a second bottle by inserting a neck or closure of the second bottle into the molded recess of the first collapsible bottle.

17. A method of providing a bottled liquid, the method comprising:
providing a vending machine comprising a collapsible bottle;
dispensing a collapsible bottle from the vending machine; and
dispensing a liquid into the collapsible bottle.

18. The method of claim 17, wherein the vending machine comprises a plurality of the collapsible bottles in a collapsed position stacked on top of one another.

19. The method of claim 17, wherein the liquid is selected from the group consisting of water, coffee, tea, juice, milk, dairy-based drinks (including yogurt), soy-based drinks, cereal-based drinks, fruit-based drinks, soda, slush, nutritional drink and combinations thereof.

20. The method of claim 17, wherein the collapsible bottle comprises a beverage concentrate in a form selected from the group consisting of powder, liquid, paste and combinations thereof.

21. The method of claim 17 comprising elongating the bottle before dispensing the liquid from the vending machine into the collapsible bottle.

22. A method of providing a beverage, the method comprising:
providing at least one collapsible bottle in the collapsed position;
elongating the collapsible bottle; and
dispensing a liquid into the collapsible bottle.

23. The method of claim 22, wherein the collapsible bottle comprises a beverage concentrate in a form selected from the group consisting of powder, liquid, paste and combinations thereof.

24. The method of claim 22, wherein the liquid is dispensed from a beverage dispensing machine.

25. The method of claim 22, wherein a plurality of collapsible bottles are provided stacked upon one another on a rack.
